(19) United States
(12) Patent Application Publication
(10) Pub. No.: US 2021/0256523 A1
(43) Pub. Date: Aug. 19, 2021

(54) SYSTEMS AND METHODS FOR INITIATING TRANSACTIONS DURING INTENDED WINDOWS BASED ON DETECTED DEVICES

(71) Applicant: LISNR, Cincinnati, OH (US)

(72) Inventors: Srivathsan Narasimhan, Saratoga, CA (US); Craig Kawahara, San Mateo, CA (US); Eric Allen, Sammamish, WA (US)

(21) Appl. No.: 17/175,958

(22) Filed: Feb. 15, 2021

Related U.S. Application Data
(60) Provisional application No. 62/976,781, filed on Feb. 14, 2020.
(60) Provisional application No. 62/977,567, filed on Feb. 17, 2020.

(51) Int. Cl. G06Q 20/40; H04W 76/11; G06Q 20/32; G07C 9/00

(52) U.S. Cl. CPC G06Q 20/4015; H04W 76/11; H04L 63/18; G07C 9/00; G06Q 20/3272

(57) ABSTRACT

Methods and systems for improved transaction initiation and processing are presented. In one embodiment, a method is provided that includes detecting a mobile device entering a merchant venue. In response, communication may be established with the mobile device and a transaction associated with the mobile device may be identified. The transaction may be pre-authorized for a predetermined time period and a pre-authorization determination may be transmitted to the mobile device. The transaction may then be processed based on the-pre-authorization determination.

### CROSS-REFERENCE TO RELATED APPLICATIONS

The present application claims priority to U.S. provisional patent application No. 62/976,781 filed on Feb. 14, 2020, and to U.S. provisional application No. 62/977,567 filed on Feb. 17, 2020, the entire contents of which are being incorporated herein by reference.

### BACKGROUND

Data often needs to be transmitted between computing devices without connecting both devices to the same computing network. For example, in certain applications, a computing network may not exist near the computing devices, or it may be too cumbersome (e.g., may take too long) to connect one or both of the computing devices to a nearby computing network. Therefore, data may be transmitted directly from one computing device to another. In some instances, initiating transactions between computing devices at specific times during which a computing network may not be available may be beneficial.

### BRIEF DESCRIPTION OF THE FIGURES

FIG. 1 illustrates a computing system according to exemplary embodiments of the present disclosure.

FIG. 2 illustrates an audio transmission, according to an exemplary embodiment of the present disclosure.

FIG. 3 illustrates a computing system, according to an exemplary embodiment of the present disclosure.

FIG. 4 illustrates an example method or process executable by a computing device, according to an exemplary embodiment of the present disclosure.

FIG. 5 illustrates a computing system, according to an exemplary embodiment of the present disclosure.

### DETAILED DESCRIPTION

Aspects of the present disclosure relate to processing transactions using audio transmissions, including establishing communication with and preauthorizing transactions based on information exchanged using ultrasonic audio transmissions.

Various techniques and systems exist to exchange data between computing devices without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired in order to transmit data according to these wireless communication protocols. Such communicative pairing can be cumbersome and slow, reducing the likelihood that users associated with one or both of the computing devices will utilize the protocols to transmit data.

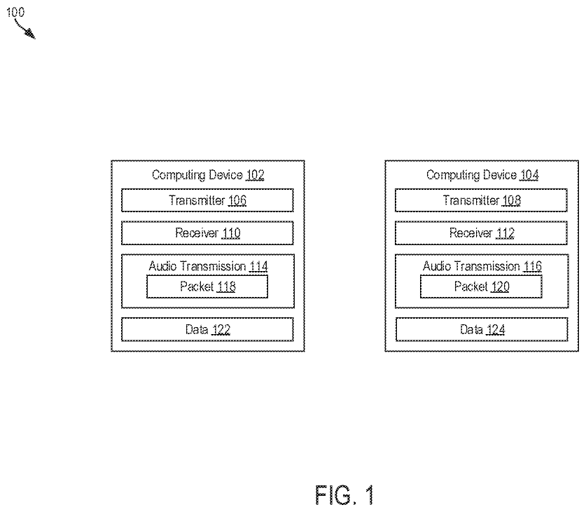

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 105 and a receiver 110, 112. The transmitters 106, 108 may include any type of device capable of generating audio signals, such as speakers. In certain implementations, the transmitters 106, 108 may be implemented as a speaker built into the computing device 102, 104. For example, one or both of the computing devices may be a smart phone, tablet computer, and/or laptop with a built-in speaker that performs the functions of the transmitter 106, 108. In other implementations, the transmitters 106, 108 may be implemented as a microphone external to the computing device 102, 104. For example, the transmitters 106, 108 may be implemented as one or more speakers externally connected to the computing device 102, 104.

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing device 102, 104. For example, one or both of the computing devices may be a smart phone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing device 102, 104 that are communicatively coupled to the computing device 102, 104. In certain implementations, the transmitter 106, 108 and receiver 110, 112 may be implemented as a single device connected to the computing device. For example, the transmitter 106, 108 and receiver 110, 112 may be implemented as a single device containing both a speaker and a microphone that is communicatively coupled to the computing device 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112. In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmission 114, 116, the computing devices 102, 104 may modulate the packets 118, 120 onto an audio carrier signal. The computing devices 102, 104 may then transmit the audio transmission 114, 116 via the transmitter 106, 108, which may then be received by the receiver 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

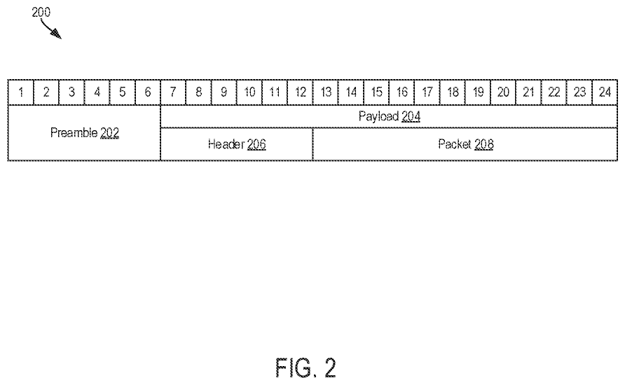

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 5 ms of the audio transmission 200. In other examples, the symbols 1-24 may correspond to other time periods within the audio transmission 200 (e.g., 1 ms, 10 ms, 20 ms, 40 ms). Each symbol 1-24 may include one or more frequencies used to encode information within the audio transmission 200. For example, the one or more frequencies may be modulated in order to encode information in the audio transmission 200 (e.g., certain frequencies may correspond to certain pieces of information). In another example, the phases of the frequencies may be additionally or alternatively be modulated in order to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined frequencies produced at predetermined points of time (e.g., according to a frequency pattern). In certain implementations, the preamble 202 may additionally or alternatively contain frequencies (e.g., a particular predetermined frequency) whose phase differences are altered by predetermined amounts at predetermined points of time (e.g., according to a phase difference pattern). The preamble 202 may be used to identify the audio transmission 200 to a computing device receiving the audio transmission 200. For example, a receiver of the computing device receiving audio transmissions such as the audio transmission 200 may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align processing of the audio transmission 200 with the symbols 1-24 of the audio transmission 200. In particular, by indicating the beginning of the audio transmission 200, the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packets 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

The preamble 202 and the payload 204 may be modulated to form the audio transmission 200 using similar encoding strategies (e.g., similar encoding frequencies). Accordingly, the preamble 202 and the payload 204 may be susceptible to similar types of interference (e.g., similar types of frequency-dependent attenuation and/or similar types of frequency-dependent delays). Proper extraction of the payload 204 from the audio transmission 200 may rely on proper demodulation of the payload 204 from an audio carrier signal. Therefore, to accurately receive the payload 204, the computing device receiving the audio transmission 200 must account for the interference.

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

In some instances, it may be beneficial to enable transmission of data (e.g., using audio transmissions) between specific types of devices, such as a mobile device and a merchant device, when a user, having a mobile device, is entering a retail store, exiting a retail store, and/or the like. In such scenarios, retail merchants may deploy merchant devices to provide product recommendations and/or facilitate product transactions for customers interacting with mobile devices. Because each merchant has a unique collection of products, a particular price for a product, particular discounts, particular incentives, and/or the like, it can be cumbersome and difficult for a merchant to determine the appropriate time during which the merchant should provide product offerings to a customer. Additionally, it can be difficult to determine the appropriate time during which the merchant should facilitate processing of product transactions (or other merchant related transactions) for a customer. For example, a merchant may not know when it is better to facilitate a transaction when a customer enters, exits, or moves from one specific location to another location within the store. Merchants may also balk at the notion of risking facilitating transactions during the wrong time window because doing so may drive a customer away with a high likelihood that the consumer will not return.

For example, when customers engage in retail activities, the customers typically have jobs to do or tasks they want to accomplish. For example, customers may often embark on shopping trips at particular retail establishments to complete particular “jobs to be done” (JTBD). Be it shopping for back to school or stocking groceries for the next week, customers often have a specific job they want to accomplish. Thus, when a customer enters a store, the customer has an intent. Either the intent was pre-planned (e.g., days or months in advance) or their intent was developed in real-time, before or after entering the store. The intensity of any shopping intent may be at the highest at the time of entry into the store. The shopping intent may be at the lowest when a customer exits the store. Thus, the intensity of a customer's intent is strongly correlated to time. The time they have allocated in that shopping trip to execute transactions may be referred to as a shopping window.

The shopping window can change based across multiple dimensions, such as: Intent—What is the customer at the store for? Intensity—How badly does the customer want complete a certain JTBD? Receptivity—How does the customer receive new information? Time—How much time does the customer have?. The disclosed system and techniques identify the correct shopping window during which a merchant should provide product recommendations and/or facilitate product transactions for customers. Additionally or alternatively, the disclosed system and techniques may help assist and pre-authorize transactions when the customer arrives in a store and automatically process payment when the customer leaves the store so the customer can focus instead on completing their JTBD.

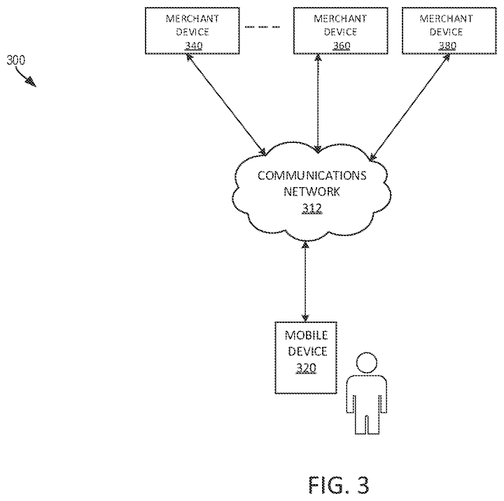

FIG. 3 provides an example system 300 that may be configured to execute one or more transactions during a specific time window at a certain location (or “merchant venue”), such as a retail establishment. As illustrated, the system 300 includes a mobile device 320 and one or more merchant devices 340, 360, 380 for use in processing a transaction. Mobile device 320 may be a mobile computing device (e.g., smartphone, tablet, laptop, etc.) configured to communicate with other components of systems 300 to perform one or more processes consistent with the disclosed embodiments. In some instances, the mobile device 320 may be configured with memory devices that store one or more operating systems that perform known operating system functions when executed by one or more processors. The operating systems may include Microsoft Windows™, Unix™, Linux™, Apple™ Computers type operating systems, mobile operating systems, such as Apple iOS™ or an Android™ operating systems, Personal Digital Assistant (PDA) type operating systems, such as Microsoft CE™, or the like. Mobile device 320 may also include memory devices storing communication software that, when executed by a processor, allows for communication with network 312, such as Web browser software, tablet or smart hand held device networking software, etc. In some embodiments, mobile device 320 may store and execute one or more mobile applications. For example, mobile device 320 may include memory devices configured to store information that may be transmitted to one or more of the merchant devices 340, 360, 380 for use in processing a transaction within a specific time window. In some instances, the mobile device 320 may be a wearable device configured to be worn or carried by a user, or otherwise be incorporated into a wearable item such as a wristband, jewelry, eyeglasses, sunglasses, watch, piece of clothing (e.g., shirt, shoe, pants, jacket, etc.), etc.

A user may carry or otherwise present the mobile device 320 within a merchant environment, such as a retail store. Based on one or more actions of the user in the merchant environment, a merchant device, such as one of the merchant devices 340, 360, 380, may detect and communicate with the mobile device 320. For example, merchant device 340 may detect the mobile device 320 performing an initiating action, which may be any action, performed at the mobile device 320, indicating that a potential transaction may have been attempted. Examples of such actions may include mobile device 320 entering a designated area (e.g., a building, a vehicle, retail location, specific area of a retail location, etc.), moving between two designated areas, receiving user input (e.g., item information), etc. As explained further below, the mobile device 320 may be detected based on an audio transmission received from the mobile device 320.

Based on detection of the initiating action, mobile device 320 and/or merchant devices 340, 360, 380 may initiate a transaction associated with the actions of the user and mobile device 320. A “transaction” may be any request, purchase, or data exchange in which a mobile device is included in the process of completing the request, purchase, or data exchange (e.g., a request for a service). For example, a transaction may be an entry-fee transaction in which the mobile device 320 initiates a payment to a merchant in order to enter an area (e.g., a museum). As another example, the transaction may include payment for products purchased in a retail store. As a further example, the transaction may include a request for service (e.g., rideshare service, pick-up service, delivery service). It is contemplated that any transaction made (and/or potential transaction denied) using a mobile device may be a transaction. Moreover, a transaction may or may not, however, be processed to completion. Whether a potential transaction should be completed may depend on an authorization determination, which may include one or more security processes. After a transaction is initiated, additional processing may take place to determine if the transaction is authorized and, if so, to complete the transaction.

One example of a situation that may be used for a transaction includes a customer purchasing an item at a retail store. As the customer enters the retail store, a merchant device, such as merchant device 340, may detect that the mobile device 320 is located within the store (e.g., detect the initiating action of entering the store). For example, the merchant device 340 may detect the mobile device 320 based on an audio transmission received from the mobile device 320. As a further example, the merchant device 340 may also transmit a predefined audio transmission containing predefined contents (e.g., a predefined audio beacon signal). In response to detecting the predefined audio transmission, the mobile device 320 may be configured to transmit an audio transmission, which may then be received by the merchant device 340. In some instances, the merchant device 340 may execute software instructions to perform one or more processes to determine whether the mobile device 320 is approved for use in transactions at the retail store. If not, the merchant device may cause the customer to be alerted that a transaction is unavailable, and the customer may be unable to complete a transaction using the mobile device 320.

After entering the retail store and receiving a successful pre-authorization determination, the customer may proceed to identify various items for purchase. The customer may use the mobile device 320 to identify the item to be purchased. For example, the customer may use an application executing on the mobile device 320 to create a transaction that includes one or more items for purchase. To add items, the customer may search for and identify particular products and/or may scan barcodes for products to add to the transaction. As the customer approaches an exit to the retail store with the identified item, the merchant device 340, 360, 380 may detect the mobile device 320, using techniques similar to those discussed above (e.g., audio transmissions). In response, the mobile device 320 and the merchant device 340, 360, 380 may share and exchange information. For example, the mobile device 320 may provide identifying information and information about the item to be purchased. The merchant device 340 may receive such information for processing. This information may be exchanged using audio transmission or other communication interfaces (e.g., network interfaces, ad hoc communication interfaces). In one specific example, the mobile device 320 may transmit an identifier to the merchant device that corresponds to the transaction created using the mobile device (e.g., an order containing indications of the products added by the customer). Through such an exchange/process, the customer may identify an item for purchase, purchase the item, and exit the store, all while avoiding a formal “checkout” process that may take up time and resources of the merchant.

Transactions may be initiated automatically via wireless communication between the mobile device 320 and another component of system 300, such as the merchant device 340, 360, 380. The mobile device 320 and the merchant device 340, 360, 380 may each include communication devices that allow for the wireless communication. Each merchant device (e.g., merchant devices 340, 360, 380) may be individually configured to interact with the mobile device 320 depending on the particular nature of the underlying merchant. For example, merchant device 340 may communicate with any mobile device (e.g., mobile device 320) that enters a particular area. Once a mobile device has entered the area, merchant device 340 may detect the mobile device 320 and begin a process to automatically initiate a transaction. If the transaction is authorized, the transaction may be completed. In some instances, processing transactions may include executing various security and authorization mechanisms that ensure only transactions approved by all parties (e.g., customer, merchant, and any others) are processed, while unauthorized transactions are blocked, such as authorization flows for payment systems like Visa®, Mastercard®, Stripe®, Apple Pay®, Google Pay®, and the like. In some aspects, components of systems 300, such as merchant devices 340, 360, 380, may be arranged to incorporate such features to provide a sufficient degree of security when processing transactions.

Merchant devices 340, 360, 380 may each be one or more computer systems associated with a merchant or other third party. Merchant devices 340, 360, 380 may include computing devices configured to execute software instructions to conduct transactions with customers (e.g., POS terminal(s), kiosks, etc.). Merchant devices 340, 360, 380 may be associated with a merchant who provides electronic shopping mechanisms, such as a website or a similar online location that consumers may access using a computer through browser software, a mobile application, or similar software. Merchant devices 340, 360, 380 may also be associated with a merchant who provides physical shopping or entertainment facilities, such as retail stores, movie theaters, museums, and the like. Merchant devices 340, 360, 380 may include computing devices that may include back and/or front-end computing components that process transactions and store consumer transaction data and execute software instructions to perform operations consistent with the disclosed embodiments.

In some instances, merchant devices 340, 360, 380 may be associated with an entity that transacts with customers. For example, the merchant may be an entity that provides goods and/or services (e.g., a museum, stadium, taxi, transit system, retail store, etc.) to customers. In the illustrated example, merchant device 340 may be associated with a merchant A, merchant device 360 may be associated with a merchant B, and merchant device 380 may be associated with a merchant C. It should be understood, however, that system 300 may include any number of merchants associated with any number of merchant devices. Additionally or alternatively, the merchant devices 340, 360, 380 may include devices located near entrances and/or exits of a merchant facility (e.g., a retail store, a museum, a stadium, a transit station) or in other locations within the facility.

In one embodiment, each of merchant 340, 360, 380 may each be associated with a different type of merchant. For example, merchant 340 may be associated with an entry-fee merchant, in which a customer may pay for entry into a location, such as a museum or a stadium. Merchant 360 may be associated with a transportation merchant, such as a subway, a taxi, or a bus. Merchant 380 may be associated with a retail merchant that sells goods and/or services, such as a grocery store, department store, clothing store, or electronics store.

In some instances, one or more computing devices associated with merchant devices 340, 360, 380 may include detection components configured to detect a mobile device (e.g., mobile device 320). For example, merchant devices 340, 360, 380 may include a beacon device configured to detect a mobile device that is located within a particular area within a range of the beacon device. In one specific example, to enable audio transmission communication between the beacon device and any mobile device, the two devices may “pair”, or communicatively couple to subsequently allow authorized and/or trusted communication between the two devices. Generally speaking, a beacon device or “beacon” represents a device that broadcasts its identity in the form of an identifier to nearby portable electronic devices, mobile devices, and/or other types of client devices.

Pairing may be initiated by the beacon device or by the mobile device 320 (i.e., the client device). For example, to pair with the mobile device 320, the beacon device may transmit, using a non-sound protocol or mechanism, a universally unique identifier (referred to as a “beacon identifier”) that can be interpreted or otherwise consumed by the mobile device, e.g., by an application or operating system running on the mobile device. For example, where a customer uses an application on the mobile device 320 to create a transaction (as explained above), the mobile device 320 may receive the beacon identifier via the application. As another example, the beacon device may transmit the identifier using an ad hoc RF transmission, such as an ad hoc WiFi or Bluetooth connection. In still further instances, the beacon device may broadcast the beacon identifier within an audio transmission. In some instances, the beacon device may also broadcast another identifier using an audio transmission (e.g., an ultrasonic signal) that includes a confirmation identifier that confirms or otherwise verifies the transmitted beacon identifier was intended for any mobile device that actually interprets the beacon identifier. For example, the beacon device may transmit an audio transmission that includes all or part of the beacon identifier and a copy of an identifier of the mobile device 320 (e.g., an identifier included in an audio transmission received from the mobile device 320 when the mobile device enters the merchant facility).

The beacon identifier may be used to determine or otherwise identify specific content and/or software services (e.g., ultrasonic services) available to the mobile device. For example, the beacon identifier may enable the beacon device to determine the mobile device's physical location, tracks the mobile device, and/or trigger a location-based action on the mobile device, such as a check-in on social media, enable a push notification, and/or the like. As a specific example, after creating a transaction, the mobile device 320 may include a copy of the beacon identifier (and/or an identifier derived from the beacon identifier) with the transaction as the transaction is updated. In particular, the transaction may be stored on a server (e.g., a database implemented by the server) associated with the merchant, and the mobile device 320 may include a copy of the beacon identifier with the transaction when transmitting copies (e.g., updated copies) of the transaction to the server as the customer adds items.

Network 312 may be any type of network that provides communications, exchanges information, and/or facilitates the exchange of information between components of system 300. In one embodiment, network 312 may be the Internet, a Local Area Network, or other suitable connection(s) that enables system 300 to send and receive information between the respective components. In other embodiments, one or more components of system 300 may communicate directly through a dedicated communication link(s) (not shown).

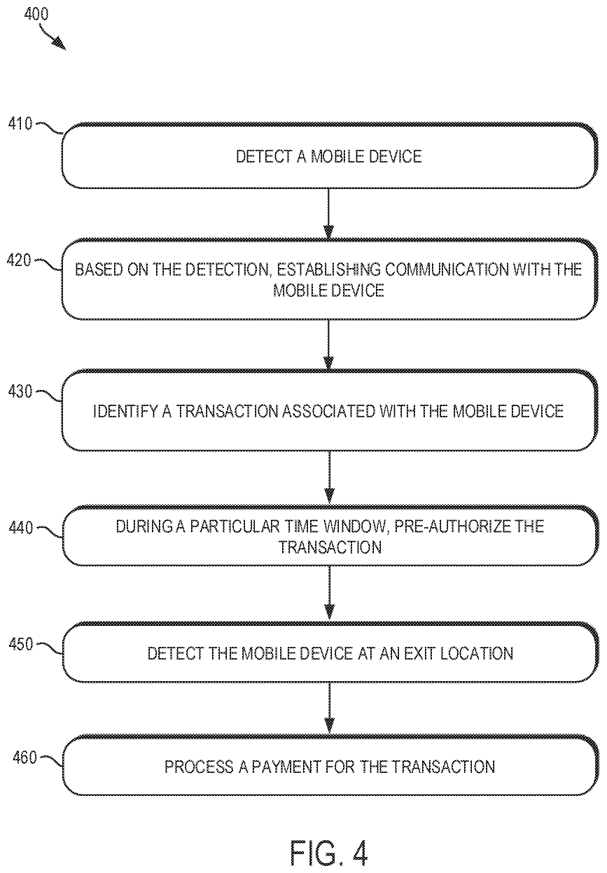

FIG. 4 depicts a flowchart of an example transaction process 400, according to aspects of the present disclosure. The process 400 may be implemented on a computer system, such as the system 300. For example, the process 400 may be implemented by the mobile device 320 and/or one or more of the merchant devices 340, 360, 380. The process 400 may also be implemented by a set of instructions stored on a computer readable medium that, when executed by a processor, cause the computer system to perform the process 400. For example, all or part of the process 400 may be implemented by a processor and a memory of the mobile device 320 and/or a merchant devices 340, 360, 380. Although the examples below are described with reference to the flowchart illustrated in FIG. 4, many other methods of performing the acts associated with FIG. 4 may be used. For example, the order of some of the operations may be changed, certain operations may be combined with other operations, one or more of the operations may be repeated, and some of the operations described may be optional.

The process 400 may begin with detecting a mobile device (operation 410). For example, a user carrying a mobile device (e.g., the mobile device 320) or otherwise associated with a mobile device may enter a merchant environment, such as a retail store. Various interactions with the mobile device may cause a merchant device to detect or otherwise identify the mobile device (e.g., the mobile device is in a particular location) and/or an action of the mobile device (the mobile device moved from one point to another). In some instances, the merchant device may use audio transmissions to detect the merchant device. For example, the merchant device may receive an audio transmission from the mobile device. As explained above, the mobile device may be configured to transmit the audio transmission in response to receiving a beacon signal from the merchant device (e.g., a beacon device included within the merchant device). As one specific example, the mobile device may be associated with a user (e.g., a customer) who enters a store. The mobile device may detect a beacon signal in an audio transmission from the merchant device and may respond with an audio transmission. The audio transmission may include a request for a beacon identifier.

After detection of the mobile device, communication with the detected mobile device may be established (operation 420). For example, the merchant device may enable communication with the mobile device. The mobile device and merchant device may communicate via any communication pathway that exists between the two components. For example, the mobile device may communicate with the merchant device using audio transmissions as described above in FIGS. 1-2. As another example, the mobile device may communicate with the merchant device via a NFC network, a WiFi network, mating RFID devices, or some other communication interface. In certain instances, establishing communication with the mobile device may include transmitting an identifier for the mobile device that can be used within a facility containing the merchant device (e.g., a store, a museum, and the like). For example, if the audio transmission received from the mobile device does not contain a beacon identifier or contains a request for a beacon identifier, establishing connection may include generating and transmitting a beacon identifier to the mobile device (e.g., via audio transmission). Continuing the previous example, the audio transmission from the customer's mobile device may include a request for a beacon identifier and/or may lack a beacon identifier. Accordingly, the merchant device may generate a beacon identifier and may transmit the beacon identifier to the mobile device. In certain implementations, transmitting the beacon identifier may include multiple transmissions (as explained above). Additionally or alternatively, the beacon identifier may be transmitted to the merchant device in a single transmission (e.g., a single audio transmission).

In certain instances, information identifying a transaction that may be associated with the mobile device may be obtained (operation 430). For example, transaction information may be received from the mobile device, and may be at least partially received via one or more audio transmissions. Continuing the previous example, the customer may walk through the store and add various items to an order for purchase (e.g., may add the items to a virtual cart) when the customer exits the store. In certain instances, all information concerning the transaction may be received by the merchant device from the mobile device via audio transmission. For example, the mobile device may transmit an audio transmission containing product identifiers and quantity information for the products added to the customer's order. In certain such implementations, updated copies of the order may be received via audio transmission as the customer walks through the store (e.g., via merchant devices located throughout the store). In still further implementations, a copy of the transaction may be received via a first communication interface by a database associated with the merchant. For example, the database may receive a copy of the transaction (e.g., a transaction identifier, product identifiers, and quantity information) via an internet connection of the mobile device, and the transaction may be updated as the user moves through the store. The mobile device may then transmit transaction identifying information to the merchant device via a second communication interface, such as audio transmissions. For example, the mobile device may transmit an audio transmission to a merchant device containing the transaction identifier that can be used to retrieve the order from the database. For example, the mobile device associated with the customer may detect another merchant device near an exit of the store (e.g., based on a received beacon signal) and may transmit the audio transmission containing the transaction identifier in response. Additionally or alternatively, the merchant device may transmit the transaction identifier upon entering the store.

In some embodiments, the transaction may be pre-authorized (operation 440). For example, as the transaction is created (e.g., on the mobile device), payment for the transaction (e.g., using pre-stored payment methods associated with the mobile device) may be pre-authorized. In certain implementations, the payment may be preauthorized for a predetermined period of time. In some aspects, pre-authorization may occur before all details of a transaction are known. For example, payment for the transaction may be pre-authorized on a credit card or other payment method for a predetermined amount. The preauthorization may also define one or more parameters for allowed transactions. As one specific example, the mobile device and/or merchant may know an age of a user associated with the mobile device and may block authorization for transactions including alcohol if the user is under the legal drinking age. As another example, a parent or other user may create transaction limits (e.g., discrete transaction limits, monthly transaction limits, weekly transaction limits) such as spending limits for the user associated with the mobile device. These parameters may be received by the merchant device by a database associated with the merchant, which may be similar to the database storing transaction information from the mobile device. Additionally or alternatively, the parameters may be included within the audio transmission received from the merchant device.

In certain implementations, a result of the pre-authorization determination may be transmitted to the mobile device. For example, the mobile device may receive the pre-authorization determination result directly from the merchant device or elsewhere. In some instances, the result may indicate that the transaction was authorized, completed, unauthorized, not completed, etc. In other instances, the result may indicate that additional information is required. If it is determined that the user is not pre-authorized to create transactions, the mobile device may block the user from creating or updating transactions (e.g., from adding items to the transaction within an application on the mobile device).

The mobile device may be detected at an exit location (operation 450). For example, a merchant device located at an exit location (e.g., the exit of a merchant location such as a store or museum) may detect the mobile device. In particular, the mobile device may be detected based on an audio transmission received from the mobile device. For instance, the mobile device may detect a beacon signal transmitted by the merchant device and may transmit an audio transmission to the merchant device.

Payment may be processed for the transaction (operation 460). For example, the merchant device and/or another computing device associated with the merchant may process a payment for the transaction associated with the mobile device. In certain implementations, the transaction may be identified based on the audio transmission received at operation 450. In particular, the transaction from the mobile device may include a transaction identifier for the transaction created by the user on the mobile device. The merchant device may then identify the corresponding transaction information (e.g., within the database) and may complete payment using the pre-authorized payment method. In implementations where the audio transmission includes all information for a transaction, the merchant device may identify the corresponding pre-authorized payment method and may process payment according to the pre-authorized payment method.

In this way, the method 400 allows for merchants to identify users as the users enter a facility. The method 400 also allows the users to create transactions within the merchant facility as the users walk through the store and to process payment automatically as the users exit the store. Also, through the use of beacon identifiers, orders can be actively associated with the correct customers and, by using audio transmissions, which have a limited physical range, it can be ensured that payments for the transactions are only processed once the users are actually exiting the store. Furthermore, pre-authorizing transactions and payment methods ensures that the user cannot create unauthorized transactions and that payments can be processed quickly as the user exits based on the pre-authorized payment amount. All of this allows for automated payment processing and improved order creating systems for merchants and avoids the need for the merchant devices and the mobile device to communicatively couple, allowing instead for ad hoc communication using audio transmissions.

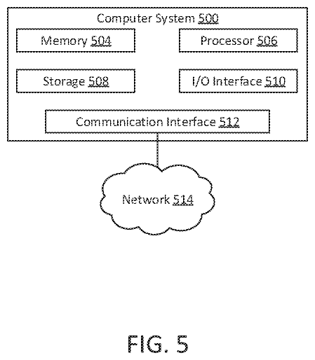

FIG. 5 illustrates an example computer system 500 that may be utilized to implement one or more of the devices and/or components of FIG. 1, such as the computing devices 102, 104 and/or the merchant devices 340, 360, 380. In particular embodiments, one or more computer systems 500 perform one or more steps of one or more methods described or illustrated herein. In particular embodiments, one or more computer systems 500 provide the functionalities described or illustrated herein. In particular embodiments, software running on one or more computer systems 500 performs one or more steps of one or more methods (e.g., process 400) described or illustrated herein or provides the functionalities described or illustrated herein. Particular embodiments include one or more portions of one or more computer systems 500. Herein, a reference to a computer system may encompass a computing device, and vice versa, where appropriate. Moreover, a reference to a computer system may encompass one or more computer systems, where appropriate.

This disclosure contemplates any suitable number of computer systems 500. This disclosure contemplates the computer system 500 taking any suitable physical form. As example and not by way of limitation, the computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 506, memory 504, storage 508, an input/output (I/O) interface 510, and a communication interface 512. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 506 includes hardware for executing instructions, such as those making up a computer program. As an example and not by way of limitation, to execute instructions, the processor 506 may retrieve (or fetch) the instructions from an internal register, an internal cache, memory 504, or storage 508; decode and execute the instructions; and then write one or more results to an internal register, internal cache, memory 504, or storage 508. In particular embodiments, the processor 506 may include one or more internal caches for data, instructions, or addresses. This disclosure contemplates the processor 506 including any suitable number of any suitable internal caches, where appropriate. As an example and not by way of limitation, the processor 506 may include one or more instruction caches, one or more data caches, and one or more translation lookaside buffers (TLBs). Instructions in the instruction caches may be copies of instructions in memory 504 or storage 508, and the instruction caches may speed up retrieval of those instructions by the processor 506. Data in the data caches may be copies of data in memory 504 or storage 508 that are to be operated on by computer instructions; the results of previous instructions executed by the processor 506 that are accessible to subsequent instructions or for writing to memory 504 or storage 508; or any other suitable data. The data caches may speed up read or write operations by the processor 506. The TLBs may speed up virtual-address translation for the processor 506. In particular embodiments, processor 506 may include one or more internal registers for data, instructions, or addresses. This disclosure contemplates the processor 506 including any suitable number of any suitable internal registers, where appropriate. Where appropriate, the processor 506 may include one or more arithmetic logic units (ALUs), be a multi-core processor, or include one or more processors 506. Although this disclosure describes and illustrates a particular processor, this disclosure contemplates any suitable processor.

In particular embodiments, the memory 504 includes main memory for storing instructions for the processor 506 to execute or data for processor 506 to operate on. As an example, and not by way of limitation, computer system 500 may load instructions from storage 508 or another source (such as another computer system 500) to the memory 504. The processor 506 may then load the instructions from the memory 504 to an internal register or internal cache. To execute the instructions, the processor 506 may retrieve the instructions from the internal register or internal cache and decode them. During or after execution of the instructions, the processor 506 may write one or more results (which may be intermediate or final results) to the internal register or internal cache. The processor 506 may then write one or more of those results to the memory 504. In particular embodiments, the processor 506 executes only instructions in one or more internal registers or internal caches or in memory 504 (as opposed to storage 508 or elsewhere) and operates only on data in one or more internal registers or internal caches or in memory 504 (as opposed to storage 508 or elsewhere). One or more memory buses (which may each include an address bus and a data bus) may couple the processor 506 to the memory 504. The bus may include one or more memory buses, as described in further detail below. In particular embodiments, one or more memory management units (MMUs) reside between the processor 506 and memory 504 and facilitate accesses to the memory 504 requested by the processor 506. In particular embodiments, the memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory implementations, this disclosure contemplates any suitable memory implementation.

In particular embodiments, the storage 508 includes mass storage for data or instructions. As an example and not by way of limitation, the storage 508 may include a hard disk drive (HDD), a floppy disk drive, flash memory, an optical disc, a magneto-optical disc, magnetic tape, or a Universal Serial Bus (USB) drive or a combination of two or more of these. The storage 508 may include removable or non-removable (or fixed) media, where appropriate. The storage 508 may be internal or external to computer system 500, where appropriate. In particular embodiments, the storage 508 is non-volatile, solid-state memory. In particular embodiments, the storage 508 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 508 taking any suitable physical form. The storage 508 may include one or more storage control units facilitating communication between processor 506 and storage 508, where appropriate. Where appropriate, the storage 508 may include one or more storages 508. Although this disclosure describes and illustrates particular storage, this disclosure contemplates any suitable storage.

In particular embodiments, the I/O Interface 510 includes hardware, software, or both, providing one or more interfaces for communication between computer system 500 and one or more I/O devices. The computer system 500 may include one or more of these I/O devices, where appropriate. One or more of these I/O devices may enable communication between a person (i.e., a user) and computer system 500. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 510 may include one or more device or software drivers enabling processor 506 to drive one or more of these I/O devices. The I/O interface 510 may include one or more I/O interfaces 510, where appropriate. Although this disclosure describes and illustrates a particular I/O interface, this disclosure contemplates any suitable I/O interface or combination of I/O interfaces.

In particular embodiments, communication interface 512 includes hardware, software, or both providing one or more interfaces for communication (such as, for example, packet-based communication) between computer system 500 and one or more other computer systems 500 or one or more networks 514. As an example and not by way of limitation, communication interface 512 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 514 and any suitable communication interface 512 for the network 514. As an example and not by way of limitation, the network 514 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 500 may include any suitable communication interface 512 for any of these networks, where appropriate. Communication interface 512 may include one or more communication interfaces 512, where appropriate. Although this disclosure describes and illustrates a particular communication interface implementations, this disclosure contemplates any suitable communication interface implementation.

The computer system 502 may also include a bus. The bus may include hardware, software, or both and may communicatively couple the components of the computer system 500 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
detecting a mobile device entering a merchant venue;
based on the detection, establishing communication with the mobile device;
identifying a transaction associated with the mobile device;
pre-authorizing the transaction for a predetermined time period;
transmitting a pre-authorization determination to the mobile device; and
processing the transaction based on the pre-authorization determination.

2. The method of claim 1, wherein the mobile device is detected by receiving an audio transmission from the mobile device.

3. The method of claim 2, wherein the audio transmission contains an identifier of the transaction.

4. The method of claim 3, wherein the transaction is stored in a database, and wherein the transaction was received by the database from the mobile device via a network connection.

5. The method of claim 1, wherein establishing communication includes transmitting a unique identifier to the mobile device using a first communication interface and communicating a communication identifier to the mobile device using a second communication interface.

6. The method of claim 5, wherein the mobile device includes the unique identifier in future communications.

7. The method of claim 6, wherein the transaction is identified based on the unique identifier.

8. The method of claim 1, further comprising:
detecting the mobile device exiting the merchant venue,
wherein the transaction is processed in response to detecting the mobile device exiting the merchant venue.

9. A system comprising:
a processor; and
a memory storing instructions which, when executed by the processor, cause the processor to:
detect a mobile device entering a merchant venue;
based on the detection, establish communication with the mobile device;
identify a transaction associated with the mobile device;
pre-authorizing the transaction for a predetermined time period;
transmitting a pre-authorization determination to the mobile device; and
process the transaction based on the pre-authorization determination.

10. The system of claim 9, wherein the mobile device is detected by receiving an audio transmission from the mobile device.

11. The system of claim 10, wherein the audio transmission contains an identifier of the transaction.

12. The system of claim 11, wherein the transaction is stored in a database, and wherein the transaction was received by the database from the mobile device via a network connection.

13. The system of claim 9, wherein establishing communication includes transmitting a unique identifier to the mobile device using a first communication interface and communicating a communication identifier to the mobile device using a second communication interface.

14. The system of claim 13, wherein the mobile device includes the unique identifier in future communications.

15. The system of claim 14, wherein the transaction is identified based on the unique identifier.

16. The system of claim 9, wherein the instructions further cause the processor:
detecting the mobile device exiting the merchant venue, and
wherein the transaction is processed in response to detecting the mobile device.

17. A non-transitory, computer-readable medium storing instructions which, when executed by a processor, cause the processor to:
detect a mobile device entering a merchant venue;
based on the detection, establish communication with the mobile device;
identify a transaction associated with the mobile device;
pre-authorizing the transaction for a predetermined time period;
transmitting a pre-authorization determination to the mobile device; and
process the transaction based on the pre-authorization determination.

18. The computer-readable medium of claim 17, wherein the mobile device is detected by receiving an audio transmission from the mobile device.

19. The computer-readable medium of claim 17, wherein the transaction is stored in a database, and wherein the transaction was received by the database from the mobile device via a network connection.

20. The computer-readable medium of claim 17, wherein establishing communication includes transmitting a unique identifier to the mobile device using a first communication interface and communicating a communication identifier to the mobile device using a second communication interface.
